(19) United States
(12) Patent Application Publication
(10) Pub. No.: US 2006/0209932 A1
(43) Pub. Date: Sep. 21, 2006

(54) Channel estimation for single-carrier systems

(75) Inventors: Aamod Khandekar, San Diego, CA (US); Avneesh Agrawal, San Diego, CA (US)

Correspondence Address: QUALCOMM INCORPORATED, 5775 MOREHOUSE DR., SAN DIEGO, CA, 92121, US

(73) Assignee: QUALCOMM Incorporated

(21) Appl. No.: 11/084,629

(22) Filed: Mar. 18, 2005

(51) Int. Cl. H04B 1/707

(52) U.S. Cl. 375/148

(57) ABSTRACT

Systems and methods are provided for processing path components in a wireless communications network. A communications system is provided that includes one or more path analyzers to determine path magnitudes with respect to a set of channel paths employed in a wireless communications network. Such analysis can include analog or digital signal processing to determine such aspects as peak energy content, phase estimates, or other parameter of a signal path. From the path determinations, one or more threshold components select a subset of the channel paths for communications based in part on the path magnitudes.

### BACKGROUND

I. Field

The subject technology relates generally to communications systems and methods, and more particularly to systems and methods that perform a magnitude and phase analysis on a set of paths received in a communications channel—a threshold component automatically selects a subset of the paths thus facilitating enhanced communications performance over RAKE-based estimators.

II. Background

In wireless communication systems, a user with a remote terminal such as a cellular phone communicates with other users over transmissions on forward and reverse links with one or more base stations. The forward link refers to transmission from the base station to the remote terminal, and the reverse link refers to transmission from the remote terminal to the base station. In some systems, for example, the total transmit power from a base station is typically indicative of the total capacity of the forward link since data may be transmitted to a number of users concurrently over a shared frequency band. A portion of the total transmit power may be allocated to each active user such that the total aggregate transmit power for all users is less than or equal to the total available transmit power.

When signals are transmitted from base station to receivers, various types of signal processing systems may be applied to reconstruct an accurate and high fidelity signal that may have arrived at the receiver from multiple communications paths. One such system for processing the respective paths is known as a RAKE receiver. The word “RAKE” is not an acronym and derives its name from inventors Price and Green in 1958. Thus, when a wideband signal is received over a multi-path channel, multiple signal delays associated with path components of the signal appear at the receiver that can be plotted or measured as voltage or current spikes. By attaching a “handle” to a plot of multi-path voltage or current signal returns, a picture of an ordinary garden rake is created. It is from this picture that the RAKE receiver derives its name. In general, RAKE receivers employ several base band correlators to individually process several signal multi-path components in a concurrent manner. The correlator outputs are then combined to achieve improved communications reliability and performance.

In many applications, both the base station and mobile receivers use RAKE receiver techniques for communications. Each correlator in a RAKE receiver is deemed a RAKE-receiver finger. The base station combines the outputs of its RAKE-receiver fingers non-coherently, whereby the outputs are added in power. The mobile receiver generally combines its RAKE-receiver finger outputs coherently, where the outputs are added in voltage. In one example system, mobile receivers typically employ three RAKE-receiver fingers whereas base station receivers utilize four or five fingers depending on the equipment manufacturer. There are two primary methods used to combine RAKE-receiver finger outputs. One method weights each output equally and is, therefore, called equal-gain combining. The second method uses the data to estimate weights which maximize the Signal-to-Noise Ratio (SNR) of the combined output. This technique is known as maximal-ratio combining.

RAKE based estimators are commonly employed for channel estimation in single-carrier systems. In such a system, RAKE “fingers” are assigned to the dominant paths in the channel. The channel magnitude for each finger is then typically computed by correlation with an appropriately delayed version of a pilot PN sequence, wherein the sequence refers to a pair of modified maximal length PN (Pseudorandom Noise) sequences utilized to spread quadrature components of a channel. An averaging filter can be employed on this channel estimate to trade-off channel estimation accuracy with Doppler tolerance, wherein the filter generally applies a finger management algorithm for assignment, de-assignment, and tracking, of the respective signal components processed at the RAKE fingers.

One problem with current finger management algorithms however, is that they generally operate at a much lower rate than the Doppler frequency. Thus, an underlying assumption is that while path magnitudes may change with the Doppler frequency, associated path locations change much more slowly. For instance, channel coherence time (inverse of the Doppler frequency) is the amount of time taken to propagate one wavelength and is given by the equation c/(fv), where c is the speed of light, f the carrier frequency and v the speed of the receiver when in motion (e.g., cell phone traveling in a car). The time taken for the path location (i.e., the propagation time) to change by one chip (transition time in a pseudo-random sequence when transmitting wireless data), however, is given by c/(Bv), where B is the bandwidth of the system (i.e., the inverse of the chip duration). For a typical system, B is several orders of magnitude smaller than f, and hence the path location generally moves much slower than the path magnitude.

The problem with the above assumption, however, is that the signal paths are in general not chip spaced, whereby an equivalent chip spaced channel is the real channel band-limited to the system bandwidth, (i.e., it is the real channel passing through a synchronization pulse). Thus, the equivalent channel has many more taps than the number of paths in the real channel. According to conventional signal processing principles, taps are components of a delay line model that represent signal propagation of a received signal in a frequency-selective communications channel such as employed in a RAKE receiver.

Generally, the finger-management algorithm described above, attempts to determine the most significant paths from among a set of paths (typically 4-5). However, chip-spaced taps in the receiver generally do not correspond directly to the channel paths and can also change as fast as the Doppler frequency. Since the finger management algorithm is not designed to track paths that change location at such speeds in view of the above assumptions, significant degradations result. These degradations include well-known problems in channel estimation schemes including fat path and finger merge problems that are the result of this assumption.

### SUMMARY

The following presents a simplified summary of various embodiments in order to provide a basic understanding of some aspects of the embodiments. This summary is not an extensive overview. It is not intended to identify key/critical elements or to delineate the scope of the embodiments disclosed herein. Its sole purpose is to present some concepts in a simplified form as a prelude to the more detailed description that is presented later.

Systems and methods are provided that facilitate wireless communications between wireless devices, between stations for broadcasting or receiving wireless signals, and/or combinations thereof. In one embodiment, signal path components which may be spaced over time are received at a destination such as cell phone or base station, for example. In general, the respective path components arrive at a receiver having varying signal magnitudes. A path analyzer (or analyzers) employs various signal processing techniques to analyze and determine the signal magnitudes. For instance, such analysis can include determining signal strength, signal power, average power, Signal-to-Noise Ratio (SNR) and so forth for the respective path components in a communications channel.

A threshold component is employed to select a subset of the signal path components for communications in view of single or multiple threshold values in order to optimize communications performance (e.g., determine a subset of the strongest signal paths by automatic comparison to a threshold value). The optimization includes trading off accuracy of received information versus Doppler tolerance. In this manner, algorithm performance can be dynamically or manually adjusted to trade off accuracy of communication as the travel velocity of a communications receiver is increased. This mitigates problems associated with conventional Rake-based estimators that rely on pre-determined chip-spaced models and thus do not properly track path components as velocity conditions change. Generally, the threshold setting is employed to trade off the probability of deleting true channel taps versus the benefit of removing noise taps, wherein the filter length trades off Doppler performance versus accuracy on static channels.

In general, processing components do not attempt to assign fingers to significant paths in the channel as performed by conventional Rake-based estimators. Rather, path magnitudes are determined for every delay (in chip multiples) in a pre-determined range. The range may be fixed or may vary depending on the expected delay spread of the channel. A “thresholding” algorithm can then determine which of these paths are significant (e.g., which paths or path has the highest average power). This algorithm may be based on retaining a fixed number of strongest paths, or on retaining paths that are above a certain energy threshold, or other consideration. It is noted, however, that thresholding decisions can be performed as fast as desired in order to tradeoff communications accuracy with higher Doppler tolerance. Furthermore, independent thresholding decisions can be made for every instance of a channel estimate. This feature is enabled since substantially all channel taps for processing path delays are available at substantially all time instants—which is in contrast to being limited to a certain number of predetermined fingers as with conventional systems.

In one embodiment, a method to process wireless signal components for a single carrier system is provided. The method includes receiving multiple signal path components over multiple communications taps and measuring signal strength of the signal path components from outputs of the communications taps. The method automatically selects a subset of the communications taps in view of the signal strength to facilitate wireless communications. In another embodiment, a communications system is provided. The system includes at least one path analyzer to determine path magnitudes with respect to a set of channel paths. A threshold component selects a subset of the channel paths based in part on the path magnitudes, wherein the subset of channel paths are employed for single carrier wireless communications.

To the accomplishment of the foregoing and related ends, certain illustrative embodiments are described herein in connection with the following description and the annexed drawings. These aspects are indicative of various ways in which the embodiments may be practiced, all of which are intended to be covered.

### BRIEF DESCRIPTION OF THE DRAWINGS

FIG. 1 is a schematic block diagram illustrating a system for selecting a channel subset in accordance with a path analyzer and threshold component.

FIG. 2 is a schematic block diagram illustrating a receiver with path measuring components.

FIG. 3 is a schematic block diagram illustrating a channel gain estimator for determining path magnitudes.

FIG. 4 is a schematic block diagram illustrating a threshold component for selecting a channel subset from a plurality of analyzed path magnitudes.

FIG. 5 is a diagram illustrating thresholding options for selecting a channel subset.

FIG. 6 is a flow diagram illustrating a path analysis and thresholding process for selecting a channel subset.

FIG. 7 is a flow diagram illustrating a dynamic selection process for selecting a channel subset.

FIG. 8 illustrates an example user interface for adjusting and controlling communications performance.

FIG. 9 illustrates an example system for employing signal processing components.

FIGS. 10 and 11 illustrate exemplary wireless communications systems that can be employed with the signal processing components.

### DETAILED DESCRIPTION

Systems and methods are provided for processing path components in a wireless communications network. In one embodiment, a communications system is provided. The system includes one or more path analyzers to determine path magnitudes having various delays with respect to a set of channel paths employed in wireless communications. Such analysis can include analog or digital signal processing to determine such aspects as peak energy content, phase analysis or other parameters of a signal path. From the path determinations, one or more threshold components select a subset of the channel paths for communications based in part on the path magnitudes. Other aspects include dynamic threshold adjustments for optimizing performance over various operating conditions. User interface components can also be provided in accordance with a device or station to control or tune the adjustments.

As used in this application, the terms “component,” “analyzer,” “system,” “tap,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a communications device and the device can be a component. One or more components may reside within a process and/or thread of execution and a component may be localized on one computer and/or distributed between two or more computers. Also, these components can execute from various computer readable media having various data structures stored thereon. The components may communicate over local and/or remote processes such as in accordance with a signal having one or more data packets (e.g., data from one component interacting with another component in a local system, distributed system, and/or across a wired or wireless network such as the Internet).

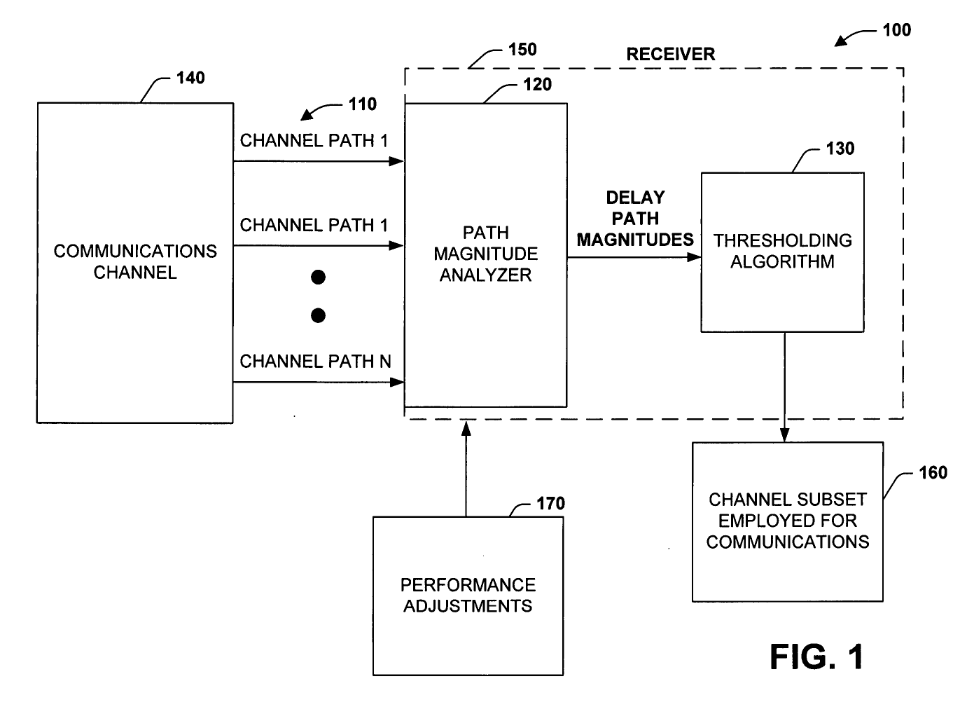

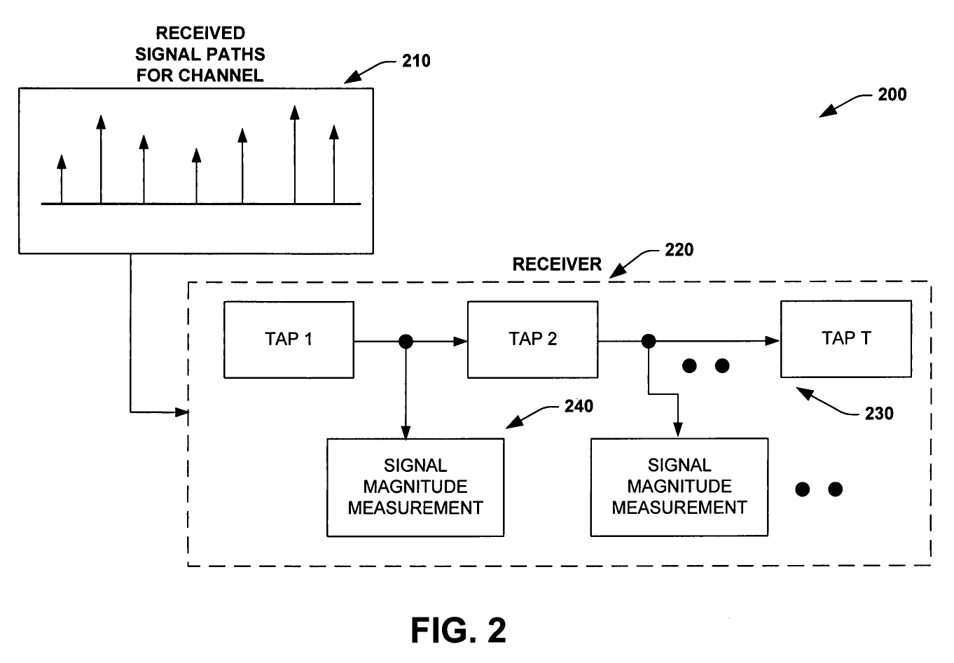

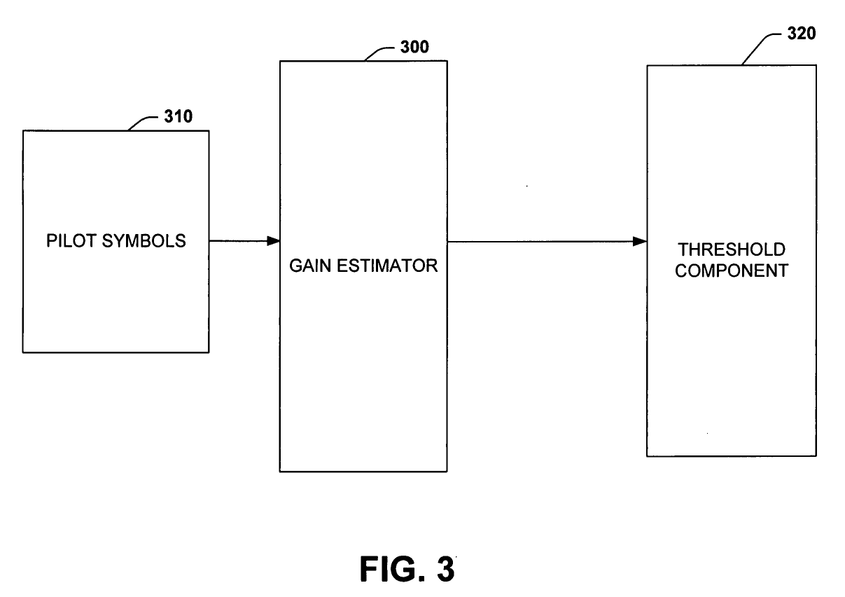

FIG. 1 illustrates a system for selecting a channel subset of channel path components 110 in accordance with a path magnitude analyzer 120 and a threshold component 130. The path components 110 which are spaced over time are received at a destination such as cell phone, base station, computer, or other device, for example. In general, the respective channel path components 110 are transmitted over a wireless communications channel 140 and arrive at a receiver 150 having varying signal magnitudes. The path magnitude analyzer 120 (or analyzers) employs various signal processing techniques to analyze and determine the signal magnitudes which are described in more detail below with respect to FIGS. 2 and 3. For instance, such analysis can include determining signal strength, signal power, average power, Signal-to-Noise Ratio (SNR), voltage or current peaks, phase angles, and so forth for the respective channel path components 110 within the communications channel 140.

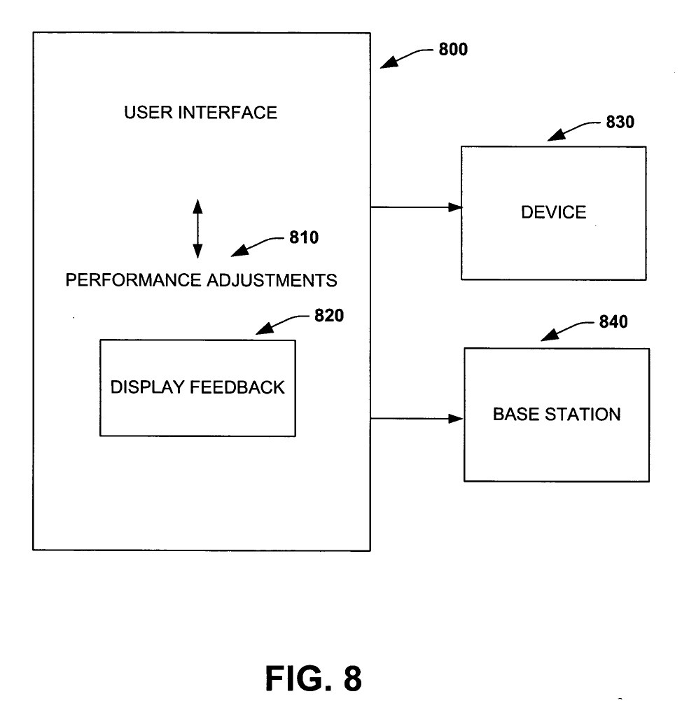

The threshold component 120 is employed to select a subset 160 of the channel path components 110 for communications in view of single or multiple threshold values in order to optimize communications performance. For example, this can include dynamically determining a subset of the strongest channel paths by automatic comparison to a threshold value. The optimization can include performing manual or automatic adjustments that trade off accuracy of received information over the communications channel 140 versus Doppler tolerance and threshold settings within the threshold component 120. The threshold setting can be employed to trade off the probability of deleting true channel taps versus the benefit of removing noise taps, wherein a filter length trades off Doppler performance versus accuracy on static channels. In this manner, receiver processing performance can be dynamically or manually adjusted to trade off accuracy of communication as the travel velocity of a communications receiver is increased. Performance adjustments 170 can be performed automatically from sensors and control loop procedures and/or manually from user interface components which are described in more detail below with respect to FIG. 8.

In general, processing components adapted do not attempt to assign fingers to significant paths in the channel as performed by conventional Rake-based estimators. Rather, channel path magnitudes 110 are determined for every delay (e.g., in chip multiples) in a pre-determined range (e.g., determine all path magnitudes for taps 8 through 16). The range may be fixed or may vary depending on the expected delay spread of the channel 140. A “thresholding” algorithm in the threshold component 130 can then determine which of these paths are significant (e.g., which paths or path has the highest power above a threshold power setting). This algorithm may be based on retaining a fixed number of strongest paths, or on retaining paths that are above a certain energy threshold, or other consideration. It is noted, however, that thresholding decisions can be made as fast as desired in order to tradeoff communications accuracy with higher Doppler tolerance, wherein the performance adjustments 170 can be employed to facilitate the tradeoff. Moreover, independent thresholding decisions can be determined for every instance of a channel estimate. This feature can be provided since all or a range of channel taps for processing path delays are available at substantially all time instants—instead of being limited to a certain number of predetermined fingers as with conventional Rake-estimation systems.

FIG. 2 illustrates a receiver 200 with one or more path measuring components for analyzing signal path components. At 210, signal paths associated with a communications channel are processed by a receiver 220. The signal paths 210 can be spread over time with modulation components at a transmitter (e.g., not shown) and combined at the receiver to determine transmitted information. Such modulation can include encoded information such as Code Division Multiple Access (CDMA) codes or other encoding format. Spreading of the signal paths can also occur due to fading which can cause multi-path signal components to occur at 210. Many propagation characteristics of the signal paths vary with differing frequencies. For instance, as a mobile communications station moves through a cell, multi-path signals abruptly add to and subtract from each other.

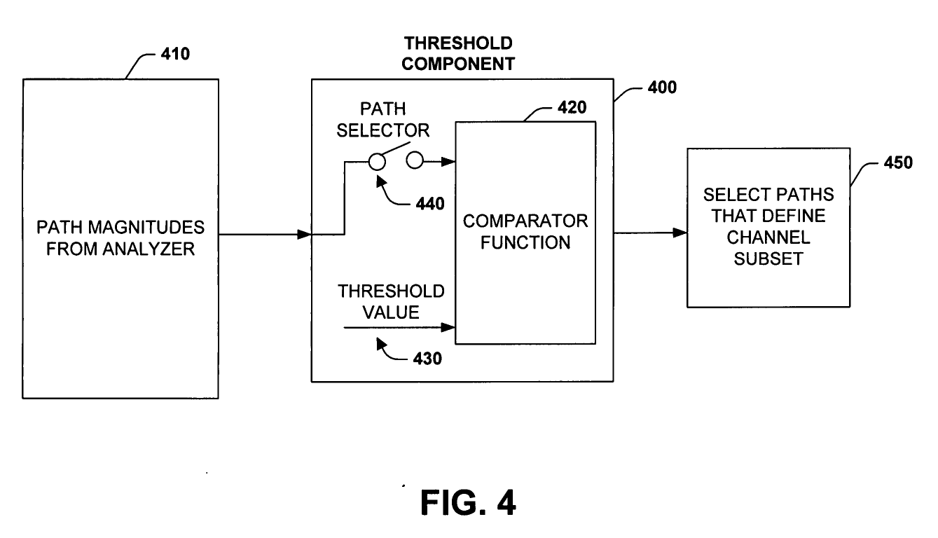

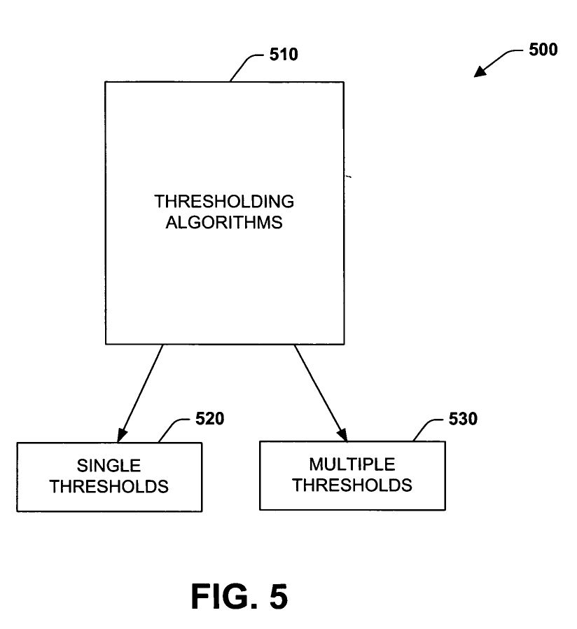

Various taps 230 can be provided to process signal paths 210. Such taps 230 can be modeled as delays in a transmission line, wherein the signal path components 210 are received by the respective taps at different points in time and subsequently combined to form a composite signal that can be decoded for information contained therein. At the outputs of the taps 230, one or more signal magnitude components 240 can be provided to measure various aspects of the signal paths 210. Such measurements can include voltage measurements, current measurements, and/or the phase angle relationships between voltage and current. Analog and/or digital sampling can occur to facilitate determinations or measurements of such parameters as peak voltage or current, peak power, SNR, average power, RMS power, power factor, phase estimates, and so forth. From these measurements or samples of the signal path components 210, a subset of the signal paths 210 can be selected by a threshold component that is described in more detail below with respect to FIGS. 4 and 5. For instance, a subset of signal paths could be selected as those signals having a determined energy content of greater than some predetermined number of Joules defined as a value parameter processed by the threshold component. It is to be appreciated that the signal measurement components 240 can be provided for each tap 230 or a subset thereof. For example, a single measuring component could be employed to perform measurements, wherein respective outputs from the taps were switched into the measurement component with a switching element such as an analog or digital multiplexer, for example.

FIG. 3 illustrates a channel gain estimator 300 as an alternative means for determining path magnitudes. Gain estimates can be determined by the gain estimator 300 in accordance with one or more pilot symbols 310. When gains for a respective path have been determined, a threshold component 320 can process the path to select a subset of channel paths as will be described in more detail below with respect to FIGS. 4 and 5. Time-domain filtering may optionally be performed on the channel response estimates for multiple symbols 310 to obtain a higher quality channel estimate. The time-domain filtering may be omitted or may be performed on frequency response estimates if desired.

FIG. 4 illustrates a threshold component 400 for selecting a channel subset from a plurality of analyzed signal path magnitudes 410 which were previously described with respect to FIG. 2 above. The threshold component 300 includes a comparator function 420 that determines whether or not a respective signal magnitude exceeds or falls below a threshold. This is illustrated at 430, wherein a threshold value (or values) are input by the comparator function 420. The threshold value 430 can be analog or digital in nature depending on the nature of the comparator function 420. For example, if the comparator is an analog comparator sampling for voltage, then the threshold value 430 can be a corresponding voltage employed for determining whether or not a signal is above or below the threshold value. Similarly, if the comparator function 420 is a digital component or algorithm, then the threshold value can be a digital code or codes that describe a threshold for comparison (e.g., all sampled signal paths below a given digital value are rejected as candidates). A path selector 440 (e.g., digital/analog switch or process) receives path magnitude output 410 from taps or other areas in a receiver circuit, wherein the path magnitudes are compared in bulk or individually by the comparator function 420. Those signal paths exceeding the threshold value 430 can be selected at 450. Alternatively, those paths falling below the threshold value 430 can be rejected.

FIG. 5 illustrates thresholding options 500 for selecting a channel subset. A thresholding algorithm 510 selects a subset of path magnitudes from a complete set of taps that model a wireless channel. This can include employment of single or multiple thresholds at 520 and 530, respectively. A threshold is used to determine whether a given element/tap has sufficient energy and should be retained or should be zeroed out. This process is referred to as “thresholding”. The threshold can be computed based on various factors and in various manners. The threshold can be a relative value (i.e., dependent on the measured channel response) or an absolute value (i.e., not dependent on the measured channel estimate). A relative threshold can be computed based on the (e.g., total or average) energy of the channel impulse response estimate. The use of the relative threshold ensures that (1) the thresholding is not dependent on variations in the received energy and (2) the elements/taps that are present but with low signal energy are not zeroed out. An absolute threshold can be computed based on the noise variance/noise floor at the receiver, the lowest energy expected for the received pilot symbols, and so on. The use of the absolute threshold forces signal path elements to meet some minimum value in order to be retained. The threshold can also be computed based on a combination of factors used for relative and absolute thresholds. For example, the threshold can be computed based on the energy of the channel estimate and further constrained to be equal to or greater than a predetermined minimum value.

In one thresholding scheme, the thresholding is performed on all tap elements of using a single threshold 520. In yet another thresholding scheme, the thresholding is performed on all P elements using multiple thresholds at 530. For example, a first threshold may be used for the first L elements, and a second threshold may be used for the last P-L elements. The second threshold may be set lower than the first threshold. In yet another thresholding scheme, the thresholding is performed on only the last P-L elements of and not on the first L elements. Thresholding is well suited for a wireless channel that is “sparse”. A sparse wireless channel has much of the channel energy concentrated in few taps. Each tap corresponds to a resolvable signal path with different time delay. A sparse channel includes few signal paths even though the delay spread (i.e., time difference) between these signal paths may be large. The taps corresponding to weak or non-existing signal paths can be zeroed out, if desired.

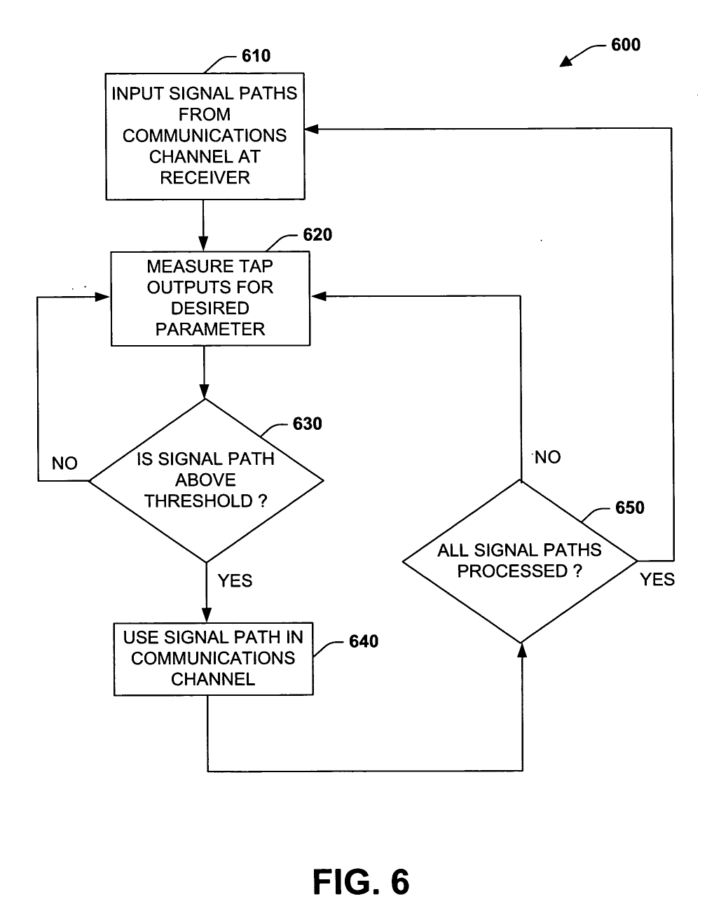

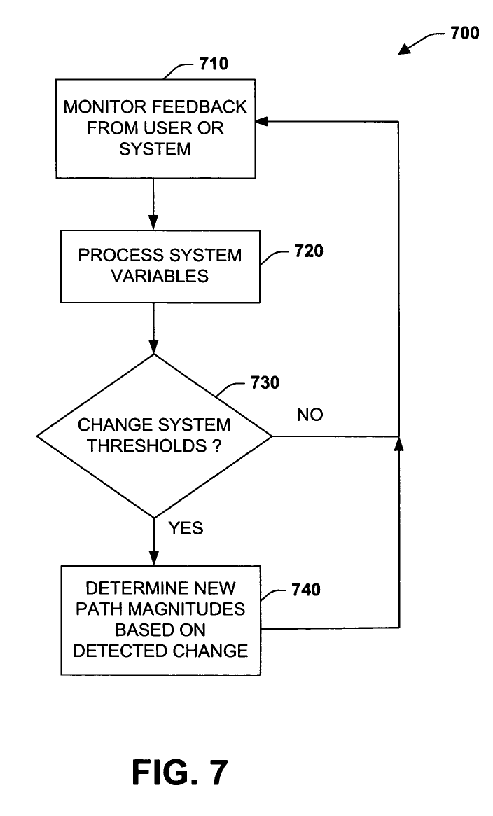

FIGS. 6 and 7, illustrate processes 600 and 700 for wireless signal processing. While, for purposes of simplicity of explanation, the methodologies are shown and described as a series or number of acts, it is to be understood and appreciated that the processes described herein are not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject methodologies disclosed herein.

FIG. 6 is a flow diagram illustrating a path analysis and thresholding process 600 for selecting a communications channel subset from a plurality or fixed range of signal paths spread over time. Proceeding to 610, signal paths from a communications are input at a receiver for further processing. It is to be appreciated that the receiver can be associated with substantially any type of device such as a cell phone, personal computer, hand held computer, or at other points in the transmission process such as at a base station. At 620, one or more tap outputs,which receive the signal paths are measured for path magnitudes. As noted above, this can include energy estimates, power estimates, gain estimates, SNR estimates, power factor estimates, phase estimates, and so forth.

At 630, a decision is made as to whether or not a received signal path is above (or below) a predetermined threshold. If the signal path is below the threshold, the signal path element for processing the signal path is ignored and the process proceeds back to 620 to process other signal path components. If the signal path is above the threshold at 630, the process proceeds to 640 and employs the respective signal path in reconstruction of the communications channel. At 650, a determination is made as to whether or not all signal path elements have been processed. If not, the process proceeds back to 620 and measure other signal path magnitudes. If all signal paths for a communications channel have been determined at 650, the process proceeds back to 610 to perform subsequent communications channel processing.

FIG. 7 is a flow diagram illustrating a dynamic selection process 700 for selecting a channel subset. Proceeding to 710, feedback is monitored from a user and/or a system. The feedback can be employed to monitor such parameters as signal to noise ratio (SNR) and Doppler frequency, for example. For instance, one manner for changing thresholding parameters can be as a fiction of the observed SNR (measured from the pilot taps) and the maximum Doppler for which the system is designed. Another example includes an algorithm (e.g., typically based on channel estimation) that would coarsely determine the observed Doppler. The feedback can also include monitoring user interface adjustments for changes in operating parameters or monitoring sensors such as a velocity sensor or an accelerometer to determine changes in speed of a mobile communications device. At 720, the feedback from 710 is processed according to the various principles and components discussed above. This can include employment of taps, filters, digital signal processors, threshold algorithms, analog components, measuring components, comparators, and so forth to perform signal magnitude processing and subset selection. At 730, a determination is made as to whether or not to perform a dynamic threshold change which controls the amount of path subsets selected. For instance, if a change in velocity is detected, threshold variables can be automatically raised or lowed as part of a closed-loop control process in order to trade off channel accuracy versus Doppler tolerance. If thresholds do not change at 730, the process proceeds back to 710 to monitor system and/or user actions. If the thresholds change at 730, new path magnitudes are determined at 740 based on the detected change. For instance, if a user changes an adjustment on a user interface (e.g., cell phone menu), thresholds can be adjusted accordingly based on received commands from the user.

FIG. 8 illustrates an example user interface 800 for adjusting and controlling communications performance. The user interface 800 can be associated with a device 820 such as a cell phone, Personal digital Assistant (PDA), laptop or personal. computer, and/or substantially any device that performs wireless communications. Also, The user interface 800 can be associated with equipment that is part of a wireless communications process such as part of a base station 830 or other communications facilitating equipment. The interface 800 can be graphical in nature or provide performance adjustment controls 840 that are keyed or coded by a device. For instance, the controls 840 could be manipulated by graphical user interface controls such as buttons or sliders or can be manipulated with other means such as a cell phone keypad having respective menu options to perform the adjustments. The user interface can include more elaborate display feedback options 850 or more elemental type displays such as an liquid crystal type display available on many cell phones.

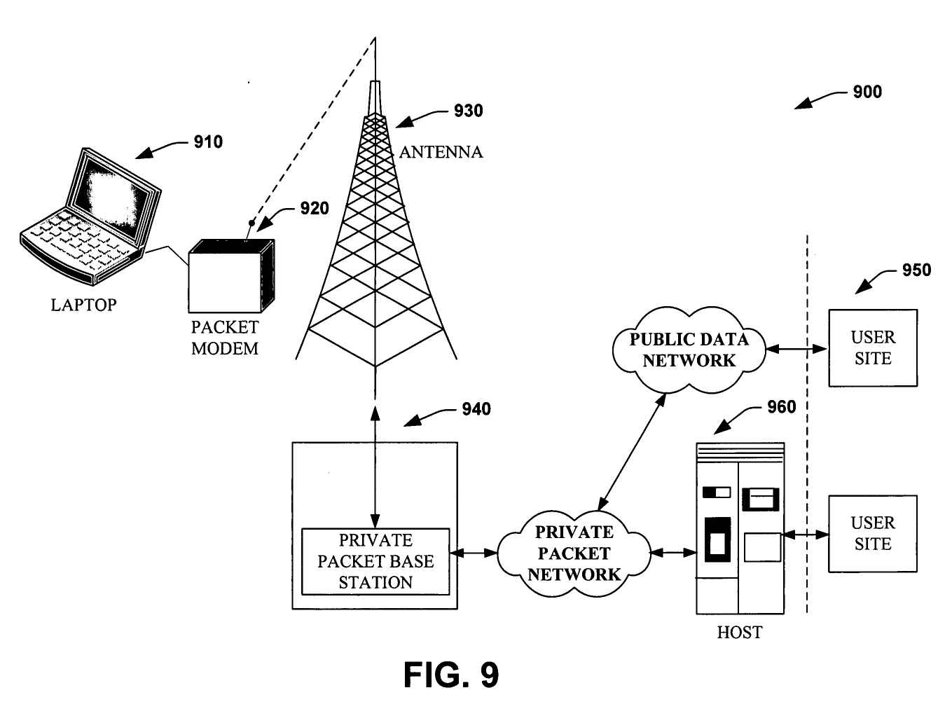

FIG. 9 illustrates an example system 900 for employing signal processing components. The system 900 illustrates some of the various example components that may employ the path magnitude and threshold components described above. These can include a personal computer 910, a modem 920 that collectively communicate over an antenna 930. Communications may proceed through a base station 940 that communicates over private or public networks to one or more user sites 950 (or devices). Also, one or more host computers 960 may be employed to facilitate communications with the other respective components in the system 900. The system 900 can employ various standards and protocols to facilitate communications.

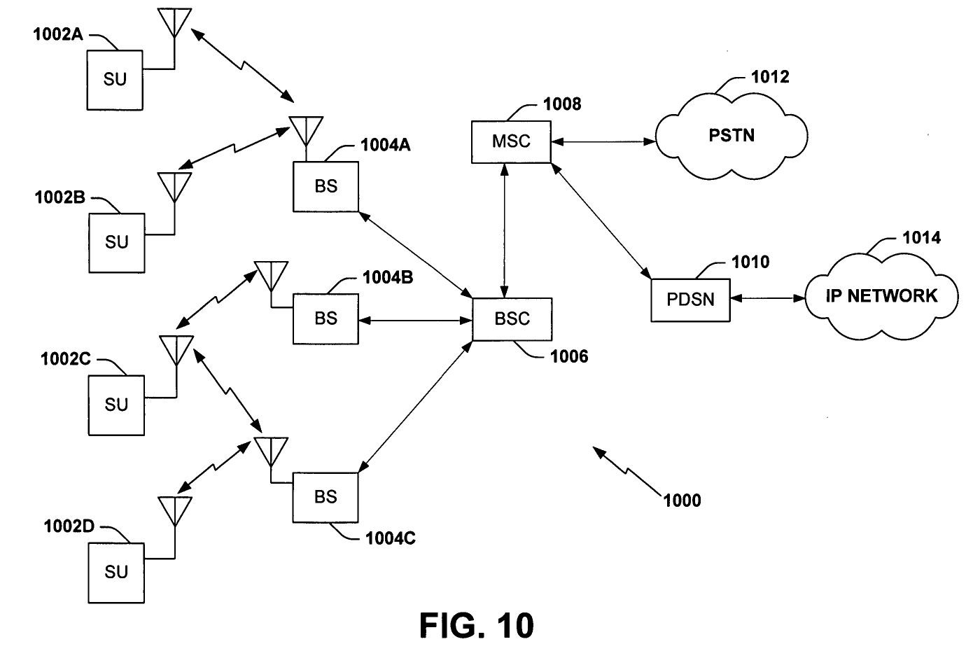

FIG. 10 is a diagram of an exemplary wireless communication network 1000 that supports a number of users and/or communications systems. For purposes of example the exemplary embodiment is described herein within the context of a CDMA cellular communications system. However, it should be understood that the embodiment is applicable to other types of communication systems, such as personal communication systems (PCS), wireless local loop, private branch exchange (PBX), or other known systems. Furthermore, systems utilizing other well known multiple access schemes such as OFDMA, TDMA and FDMA as well as other spread spectrum systems may employ the presently disclosed method and apparatus.

The wireless communication network 1000 generally includes a plurality of subscriber units 1002a-1002d, a plurality of base stations 1004a-1004c, a base station controller (BSC) 1006 (also referred to as radio network controller or packet control function), a mobile station controller (MSC) or switch 1008, a packet data serving node (PDSN) or internet-working function (IWF) 1010, a public switched telephone network (PSTN) 1012 (typically a telephone company), and a packet network 1014 (typically the Internet). For purposes of simplicity, four subscriber units 1002a-1002d, three base stations 1004a-1004c, one BSC 1006, one MSC 1008, and one PDSN 1010 are shown with a PSTN 1012 and an IP network 1014. It would be understood by those skilled in the art that there could be any number of subscriber units 1002, base stations 1004, BSCs 1006, MSCs 1008, and PDSNs 1010 in the wireless communication network 1000.

Wireless communication network 1000 provides communication for a number of cells, with each cell being serviced by a corresponding base station 1004. Various subscriber units 1002 are dispersed throughout the system. The wireless communication channel through which information signals travel from a subscriber unit 1002 to a base station 1004 is known as a reverse link. The wireless communication channel through which information signals travel from a base station 1004 to a subscriber unit 1002 is known as a forward link. Each subscriber unit 1002 may communicate with one or more base stations 1004 on the forward and reverse links at any particular moment, depending on whether or not the subscriber unit is in soft handoff.

As shown in FIG. 10, base station 1004a communicates with subscriber units 1002a and 1002b, base station 1004b communicates with subscriber unit 1002c, and base station 1004c communicates with subscriber units 1002c and 1002d. Subscriber unit 1002c is in soft handoff and concurrently communicates with base stations 1004band 1004c. In wireless communication network 1000, a BSC 1006 couples to base stations 1004 and may further couple to a PSTN 1012. The coupling to PSTN 1012 is typically achieved with an MSC 1008. BSC 1006 provides coordination and control for the base stations coupled to it. BSC 1006 further controls the routing of telephone calls among subscriber units 1002, and between subscriber units 1002 and users coupled to the PSTN (e.g., conventional telephones) 1012 and to the packet network 1014, through base stations 1004.

In one embodiment, the wireless communication network 1000 is a packet data services network. In another embodiment, the BSC 1006 is coupled to a packet network with a PDSN 1010. An Internet Protocol (IP) network is an example of a packet network that can be coupled to BSC 1006 through PDSN 1010. In another embodiment, the coupling of BSC 1006 to PDSN 1010 is achieved with an MSC 1008. In one embodiment, the IP network 1014 is coupled to the PDSN 1010, the PDSN 1010 is coupled to the MSC 1008, the MSC 1008 is coupled to the BSC 1006 and the PSTN 1012, and the BSC 1006 is coupled to the base stations 1004a-1004c over wirelines configured for transmission of voice and/or data packets in accordance with any of several known protocols including, e.g., E 1 , T1, Asynchronous Transfer Mode (ATM), IP, PPP, Frame Relay, HDSL, ADSL, or xDSL. In another embodiment, the BSC 1006 is coupled directly to the PDSN 1010, and the MSC 1008 is not coupled to the PDSN 1010. In one embodiment, the subscriber units 1002a-1002d communicate with the base stations 1004a-1004c over an RF interface.

The subscriber units 1002a-1002d may be configured to perform one or more wireless packet data protocols. In one embodiment, the subscriber units 1002a-1002dgenerate IP packets destined for the IP network 1014 and encapsulate the IP packets into frames using a point-to-point protocol (PPP). The subscriber units 1002a-1002dmay be any of a number of different types of wireless communication devices such as a portable phone, a cellular telephone that is connected to a laptop computer running IP-based, Web-browser applications, a cellular telephone with an associated hands-free car kit, a personal digital assistant (PDA) running IP-based, Web-browser applications, a wireless communication module incorporated into a portable computer, or a fixed location communication module such as might be found in a wireless local loop or meter reading system. In the most general embodiment, subscriber units may be any type of communication unit.

During typical operation of the wireless communication network 1000, the base stations 1004a-1004c receive and demodulate sets of reverse-link signals from various subscriber units 1002a-1002dengaged in telephone calls, Web browsing, or other data communications. Each reverse-link signal received by a given base station 1004a-1004cis processed within that base station 1004a-1004c. Each base station 1004a-1004cmay communicate with a plurality of subscriber units 1002a-1002dby modulating and transmitting sets of forward-link signals to the subscriber units 1002a-1002dFor example, as shown in FIG. 1, the base station 1004a communicates with subscriber units 1002aand 1002b concurrently, and base station 1004c communicates with subscriber units 1002c and 1002dconcurrently. The resulting packets are forwarded to the BSC 1006, which provides call resource allocation and mobility management functionality including the orchestration of soft handoffs of a call for a particular subscriber unit 1002a-1002dfrom an originating base station 1004a-1004cto destination base station 1004a-1004c. Eventually, when the subscriber unit 1002cmoves far enough away from base station 1004c, the call will be handed off to another base station. If subscriber unit 1002c moves close enough to base station 1004b, the call will be handed off to base station 1004b.

If the transmission is a conventional telephone call, the BSC 1006 will route the received data to the MSC 1008, which provides additional routing services for interface with the PSTN 1012. If the transmission is a packet-based transmission such as a data call destined for the IP network 1014, the MSC 1008 will route the data packets to the PDSN 1010, which will send the packets to the IP network 1014. Alternatively, the BSC 1006 routes the packets directly to the PDSN 1010, which sends the packets to the IP network 1014.

The system 1000 may be designed to support one or more CDMA standards such as (1) the “TINEIA-95-B Mobile Station-Base Station Compatibility Standard for Dual-Mode Wideband Spread Spectrum Cellular System” (the IS-95 standard), (2) the documents offered by a consortium named “3rd Generation Partnership Project” (3GPP) and embodied in a set of documents including Document Nos. 3G TS 25.211, 3G TS 25.212, 3G TS 25.213, and 3G TS 25.214 (the W-CDMA standard), and (3) the documents offered by a consortium named “3rd Generation Partnership Project 2” (3GPP2) and embodied in a set of documents including Document Nos. C.S0002-A, C.S0005-A, C.S0010-A, C.S0011-A. C.S0024, C.S0026, C.P9011, and C.P9012 (the cdma2000 standard). In the case of the 3GPP and 3GPP2 documents, these are converted by standards bodies world-wide (e.g., TIA, ETSI, ARIB, TTA, and CWTS) into regional standards and have been converted into international standards by the International Telecommunications Union (ITU). These standards are incorporated herein by reference.

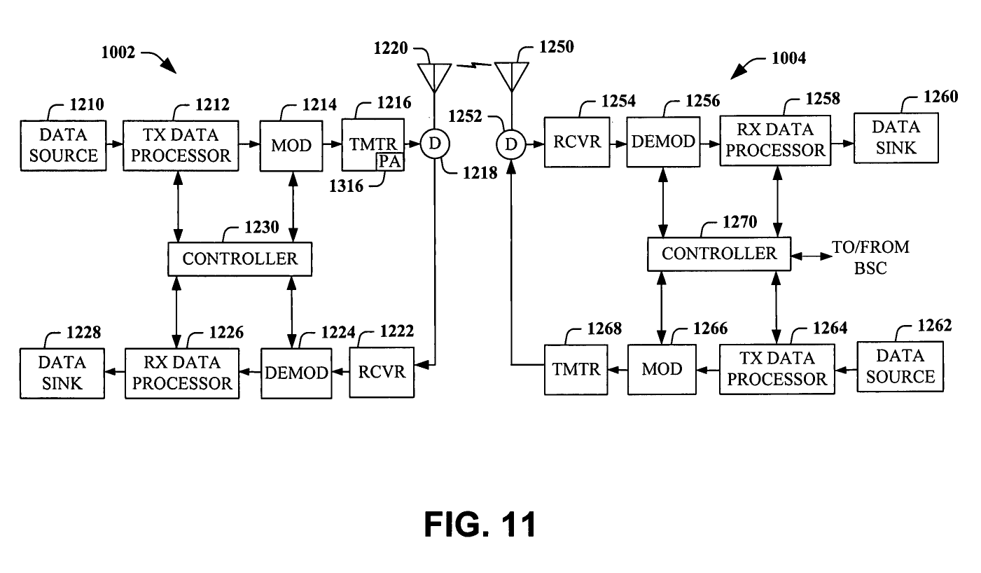

FIG. 11 is a simplified block diagram of an embodiment of subscriber unit 1002 and a base station 1004, which are capable of implementing various embodiments described herein. For a particular communication, voice data, packet data, and/or messages may be exchanged between a subscriber unit 1002 and a base station 1004. Various types of messages may be transmitted such as messages used to establish a communication session between the base station 1004 and the sub-scriber unit 1002 and messages used to control a data transmission (e.g., power control, data rate information, acknowledgment, and so on).

For the reverse link, at subscriber unit 1002, voice and/or packet data (e.g., from a data source 1210) and messages (e.g., from a controller 1230) are provided to a transmit (TX) data processor 1212, which formats and encodes the data and messages with one or more coding schemes to generate coded data. The transmit data processor 1212 includes a code generator that implements the one or more coding schemes. Output digits of the code generator are commonly termed chips. A chip is a single binary digit. Thus, a chip is an output digit of the code generator.

Each coding scheme may include any combination of cyclic redundancy check (CRC), convolutional, Turbo, block, and other coding, or no coding at all. Typically, voice data, packet data, and messages are coded using different schemes, and different types of message may also be coded differently. The coded data is then provided to a modulator (MOD) 1214 and further processed (e.g., covered, spread with short PN sequences, and scrambled with a long PN sequence assigned to the user terminal). In one embodiment, the coded data is covered with Walsh codes, spread with a long PN code, and further spread with short PN codes. The spread data is then provided to a transmitter unit (TMTR) 1216 and conditioned (e.g., converted to one or more analog signals, amplified, filtered, and quadrature modulated) to generate a reverse link signal. Transmitter unit 1216 includes a power amplifier 1316 that amplifies the one or more analog signals. The reverse link signal is routed through a duplexer (D) 1218 and transmitted over an antenna 1220 to base station 1004.

The transmission of the reverse link signal occurs over a period of time called transmission time. Transmission time is partitioned into time units. In one embodiment, the transmission time may be partitioned into frames. In another embodiment, the transmission time may be partitioned into time slots. A time slot is a duration of time. In accordance with one embodiment, data is partitioned into data packets, with each data packet being transmitted over one or more time units. At each time unit, the base station can direct data transmission to any subscriber unit, which is in communication with the base station. In one embodiment, frames may be further partitioned into a plurality of time slots. In yet another embodiment, time slots may be further partitioned. For example, a time slot may be partitioned into half-slots and quarter-slots.

In one embodiment, the modulator 1214 includes a peak-to-average reduction module that reduces the peak-to-average power ratio of the reverse link signal. Within the modulator 1214, the peak-to-average reduction module is located after the spread data is filtered. In another embodiment, the peak-to-average reduction module is located within the transmitter 1216. In yet another embodiment, the peak-to-average reduction module is located between the modulator 1214 and the transmitter 1216.

At base station 1004, the reverse link signal is received by an antenna 1250, routed through a duplexer 1252, and provided to a receiver unit (RCVR) 254, which conditions (e.g., filters, amplifies, downconverts, and digitizes) the received signal and provides samples. A demodulator (DEMOD) 1256 receives and processes (e.g., despreads, decovers, and pilot demodulates) the samples to provide recovered symbols. Demodulator 1256 may implement a rake receiver that processes multiple instances of the received signal and generates combined symbols. A receive (RX) data processor 1258 then decodes the symbols to recover the data and messages transmitted on the reverse link. The recovered voice/packet data is provided to a data sink 1260 and the recovered messages may be provided to a controller 1270. The processing by demodulator 1256 and RX data processor 1258 are complementary to that performed at subscriber unit 1002. Demodulator 1256 and RX data processor 1258 may farther be operated to process multiple transmissions received over multiple channels, e.g., a reverse fundamental channel (R-FCH) and a reverse supplemental channel (R-SCH). Also, transmissions may be received concurrently from multiple subscriber units 1002, each of which may be transmitting on a reverse fundamental channel, a reverse supplemental channel, or both.

On the forward link, at base station 1004, voice and/or packet data (e.g., from a data source 1262) and messages (e.g., from controller 1270) are processed (e.g., formatted and encoded) by a transmit (TX) data processor 1264, further processed (e.g., covered and spread) by a modulator (MOD) 1266, and conditioned (e.g., converted to analog signals, amplified, filtered, and quadrature modulated) by a transmitter unit (TMTR) 1268 to generate a forward link signal. The forward link signal is routed through duplexer 1252 and transmitted through antenna 1250 to subscriber unit 1002.

At subscriber unit 1002, the forward link signal is received by antenna 1220, routed through duplexer ′218, and provided to a receiver unit ′222. Receiver unit 1222 conditions (e.g., downconverts, filters, amplifies, quadrature demodulates, and digitizes) the received signal and provides samples. The samples are processed (e.g., despreaded, decovered, and pilot demodulated) by a demodulator 1224 to provide symbols, and the symbols are further processed (e.g., decoded and checked) by a receive data processor 1226 to recover the data and messages transmitted on the forward link. The recovered data is provided to a data sink 1228, and the recovered messages may be provided to controller 1230.

What has been described above includes exemplary embodiments. It is, of course, not possible to describe every conceivable combination of components or methodologies for purposes of describing the embodiments, but one of ordinary skill in the art may recognize that many further combinations and permutations are possible. Accordingly, these embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method to process wireless signal components for a single carrier system, comprising:
receiving multiple signal path components over multiple communications taps;
measuring signal strength of the signal path components from outputs of the communications taps; and
automatically selecting a subset of the communications taps in view of the signal strength to facilitate wireless communications.

2. The method of claim 1, further comprising thresholding the multiple signal path components to determine the subset of the communications taps.

3. The method of claim 1, further comprising determining at least one of a path magnitude, an energy estimate, a power estimate, a gain estimate, a signal to noise ratio estimate (SNR), a phase estimate, and a power factor estimate to determine the communications taps.

4. The method of claim 3, further comprising determining a control to adjust the thresholding of the multiple signal path components.

5. The method of claim 4, further comprising providing feedback to a user or system to facilitate selection of the multiple signal path components.

6. A method to dynamically control a wireless communications channel, comprising:
monitoring feedback relating to a control variable associated with selection of a group of signal paths;
applying a threshold value to determine the group of signal paths; and
controlling the group of signal paths according to the threshold value.

7. The method of claim 6, the feedback is related to a sensor or an adjustment provided by a user or system.

8. The method of claim 6, the feedback is related to a signal to noise ratio or a Doppler frequency.

9. A wireless communications system, comprising:
means for processing signal components associated with a communications path;
means for measuring the signal components; and
means for selecting a group of signal magnitudes from the signal components that are employed for single carrier wireless communications.

10. The system of claim 9, further comprising means for testing at least one threshold value to select the subset of channel paths.

11. The system of claim 10, further comprising means for dynamically adjusting the threshold value.

12. The system of claim 9, further comprising means for sensing feedback to facilitate selection of the signal magnitudes.

13. The system of claim 9, further comprising means for measuring one or more signal parameters of the signal components.

14. The system of claim 13, the signal parameters include peak voltage or current, peak power, peak energy, Signal to Noise Ratio (SNR), average power, Root Mean Square power, or power factor.

15. A communications system, comprising:
at least one path analyzer to determine path magnitudes with respect to a set of channel paths; and
at least one threshold component to select a subset of the channel paths based in part on the path magnitudes, the subset of channel paths employed for single carrier wireless communications.

16. The system of claim 15, at least one of the path analyzer and the threshold component are associated with a receiving device or a processing station that transmits or receives wireless signals.

17. The system of claim 15, the threshold component is configured to employ at least one threshold value to select the subset of channel paths.

18. The system of claim 17, further comprising a control component to dynamically adjust the threshold value.

19. The system of claim 18, the control component is configured to monitor system or user feedback to adjust the threshold value.

20. The system of claim 19, further comprising a user interface to adjust the threshold value.

21. The system of claim 19, further comprising one or more taps to process the path magnitudes.

22. The system of claim 21, the path magnitudes include encoded information associated with Code Division Multiple Access (CDMA) codes.

23. The system of claim 21, further comprising a switch component to determine one or more parameters from the taps.

24. The system of claim 23, further comprising a gain estimator to determine the parameters.

25. The system of claim 23, the parameters include peak voltage or current, peak power, peak energy, Signal to Noise Ratio (SNR), average power, Root Mean Square power, or a phase estimate.

26. The system of claim 15, further comprising a processor to execute computer readable instructions related to the path analyzer and the threshold component.

27. A computer readable medium having a data structure stored thereon for wireless communications, comprising:
at least one data field describing a threshold parameter employed to select a signal subset from a larger collection of signals on a wireless communications channel;
at least a second data field employed to store information relating to the signal subset; and
at least a third data field to store magnitude measurement data for the signal subset.

28. A signal associated with a data packet for wireless communications, comprising:
a first data packet to communicate threshold information associated with a set of signal paths;
a second data packet to communicate measurement information for the set of signal paths; and
a third data packet to select a group of taps in view of the measurement information in order to process a reduced set of signal paths for wireless communications.

29. The signal of claim 28, further comprising a data packet to encode information within the set of signal paths.

30. A microprocessor that executes computer implemented instructions to process wireless signal components for a single carrier system that comprise:
measuring signal strength of received signal path components from outputs of communications taps; and
automatically selecting a subset of the communications taps in view of the signal strength to facilitate wireless communications.

31. The computer implemented instructions executable by the microprocessor of claim 30, further comprising: thresholding the multiple signal path components to determine the subset of the communications taps.

32. The computer implemented instructions executable by the microprocessor of claim 30, further comprising:
determining at least one of a path magnitude, an energy estimate, a power estimate, a gain estimate, a signal to noise ratio estimate (SNR), a phase estimate, and a power factor estimate to determine the communications taps.

33. The computer implemented instructions executable by the microprocessor of claim 30, further comprising:
determining a control to adjust the thresholding of the multiple signal path components.

34. The computer implemented instructions executable by the microprocessor of claim 30, further comprising:
providing feedback to a user or system to facilitate selection of the multiple signal path components.

35. A microprocessor that executes computer implemented instructions that comprise:
monitoring signal feedback relating to a control variable associated with a set of signalpaths;
applying a threshold value to determine the set of signal paths; and
controlling the set of signal paths according to the threshold value.
